(19) United States
(12) Patent Application Publication
(10) Pub. No.: US 2018/0350358 A1
(43) Pub. Date: Dec. 6, 2018

(54) VOICE RECOGNITION DEVICE, VOICE EMPHASIS DEVICE, VOICE RECOGNITION METHOD, VOICE EMPHASIS METHOD, AND NAVIGATION SYSTEM

(71) Applicant: MITSUBISHI ELECTRIC CORPORATION, Tokyo (JP)

(72) Inventor: Yuki TACHIOKA, Tokyo (JP)

(73) Assignee: MITSUBISHI ELECTRIC CORPORATION, Tokyo (JP)

(21) Appl. No.: 15/779,315

(22) PCT Filed: Dec. 1, 2015
(86) PCT No.: PCT/JP2015/083768

§ 371 Date: May 25, 2018

(51) Int. Cl. G10L 15/20; G10L 21/0264; G10L 25/12

(52) U.S. Cl. CPC G10L 15/20; G10L 25/12; G10L 21/0264

(57) ABSTRACT

A device includes a plurality of noise suppressing units (3) performing respective noise suppressing processes using different methods on voice data with noise inputted thereto. The device further includes: a voice recognition unit (4) carrying out voice recognition on sound data generated by suppressing a noise signal in the voice data with noise; a predicting unit (2) predicting, from acoustic feature quantities of the inputted voice data with noise, voice recognition rates which are to be provided when the noise suppressing processes are performed on the voice data with noise by the plurality of noise suppressing units (3), respectively; and a suppressing method selecting unit (2) selecting a noise suppressing unit (3) which performs a noise suppressing process on the voice data with noise from the plurality of noise suppressing units on a basis of the predicted voice recognition rates.

### TECHNICAL FIELD

The present invention relates to a voice recognition technique and a voice emphasis technique. Particularly, it relates to a technique being suitable for use under various noise environments.

### BACKGROUND ART

In a case of carrying out voice recognition using a voice on which noise is overlapping, it is general to perform a process of suppressing the overlapping noise (which is referred to as a noise suppressing process hereafter) before performing the voice recognition process. Because of the characteristics of the noise suppressing process, there exist noise for which the noise suppressing process is effective and noise for which the noise suppressing process is not effective. For example, in a case in which the noise suppressing process is a spectral subtracting process strongly effective against stationary noise, the subtracting process is weakly effective against non-stationary noise. In contrast, in a case in which the noise suppressing process has high followability to non-stationary noise, the process has low followability to stationary noise. As a method for solving this problem, conventionally, integration of voice recognition results, or selection of voice recognition results are used.

According to the above conventional methods, when a voice on which noise is overlapping is inputted, the noise is suppressed and two voices are acquired by, for example, using two noise suppressing units: one that performs a suppressing process having high followability to stationary noise; and one that performs a suppressing process having high followability to non-stationary noise, and voice recognition is carried out on the two acquired voices by two voice recognition units, respectively. The two voice recognition results acquired through the voice recognition are integrated using a voice connection method such as the ROVER (Recognition Output Voting Error Reduction), or the voice recognition result having higher likelihood is selected from the two voice recognition results, and either the integrated voice recognition result or the selected voice recognition result is outputted. However, in such a conventional method, though the recognition accuracy can be significantly improved, there is a problem that the processing for voice recognition is increased.

As a method for solving this problem, for example, Patent Literature 1 discloses a voice recognition device that calculates the likelihood of an acoustic feature parameter of inputted noise for each of probability sound models, and selects a probability acoustic model on the basis of the likelihood is disclosed. Further, Patent Literature 2 discloses a signal discrimination device that, after removing noise from an object signal inputted thereto and performing preprocessing to extract feature quantity data showing features of the object signal, classifies the object signal into multiple categories in accordance with the shape of a clustering map of a competitive neural network, and automatically selects the content of processing.

### CITATION LIST

### Patent literature

Patent Literature 1: Japanese Unexamined Patent Application Publication No. 2000-194392

Patent Literature 2: Japanese Unexamined Patent Application Publication No. 2005-115569

### SUMMARY OF INVENTION

### Technical Problem

However, in the technique disclosed in the above Patent Literature 1, there is a problem that a noise suppressing process providing a good voice recognition rate or a good acoustic index may not be selected, since the likelihood of an acoustic feature parameter of inputted noise for each of probability sound models is used. Further, in the technique disclosed in Patent Literature 2, although clustering of an object signal is carried out, the clustering is not performed to be linked to a voice recognition rate or an acoustic index. Therefore, there is a problem that a noise suppressing process which shows a high voice recognition rate or a high acoustic index is not selected in some cases. Further, there is a common problem for the above two methods: because a voice after a noise suppressing process is needed in order to predict the performance, all candidates for the noise suppressing process have to be performed once both in the learning process and in the voice recognition process.

The present invention is made in order to solve the above problems, and it is therefore an object of the present invention to provide a technique for selecting, with high accuracy, a noise suppressing process which provides a good voice recognition rate or a good acoustic index only from voice data with noise without performing noise suppressing process in order to select a noise suppressing method.

### Solution to Problem

A voice recognition device according to the present invention includes: a plurality of noise suppressing units performing respective noise suppressing processes using different methods on voice data with noise inputted thereto; a voice recognition unit carrying out voice recognition on sound data generated by suppressing a noise signal in the voice data with noise by one of the noise suppressing units; a predicting unit predicting, from acoustic feature quantities of the voice data with noise being inputted, voice recognition rates which are to be provided when the noise suppressing processes are performed on the voice data with noise by the plurality of noise suppressing units, respectively; and a suppressing method selecting unit selecting a noise suppressing unit which performs a noise suppressing process on the voice data with noise from the plurality of noise suppressing units on a basis of the voice recognition rates predicted by the predicting unit.

### Advantageous Effects of Invention

According to the present invention, a noise suppressing process which provides a good voice recognition rate or a good acoustic index is selected without performing noise suppressing process in order to select a noise suppressing method.

### BRIEF DESCRIPTION OF DRAWINGS

FIG. 1 is a block diagram showing a configuration of a voice recognition device according to the Embodiment 1;

FIGS. 2A and 2B are diagrams showing hardware configuration of the voice recognition device according to the Embodiment 1;

FIG. 3 is a flowchart showing an operation of the voice recognition device according to the Embodiment 1;

FIG. 4 is a block diagram showing a configuration of a voice recognition device according to the Embodiment 2;

FIG. 5 is a flowchart showing an operation of the voice recognition device according to the Embodiment 2;

FIG. 6 is a block diagram showing a configuration of a voice recognition device according to the Embodiment 3;

FIG. 7 is a diagram showing an example of a configuration of a recognition rate database of the voice recognition device according to the Embodiment 3;

FIG. 8 is a flowchart showing an operation of the voice recognition device according to the Embodiment 3;

FIG. 9 is a block diagram showing a configuration of a voice emphasis device according to the Embodiment 4;

FIG. 10 is a flow chart showing an operation of the voice emphasis device according to the Embodiment 4; and

FIG. 11 is a functional block diagram showing a configuration of a navigation system according to the Embodiment 5.

### DESCRIPTION OF EMBODIMENTS

Hereafter, in order to explain the present invention in more detail, some embodiments of the present invention will be described with reference to the accompanying drawings.

### Embodiment 1

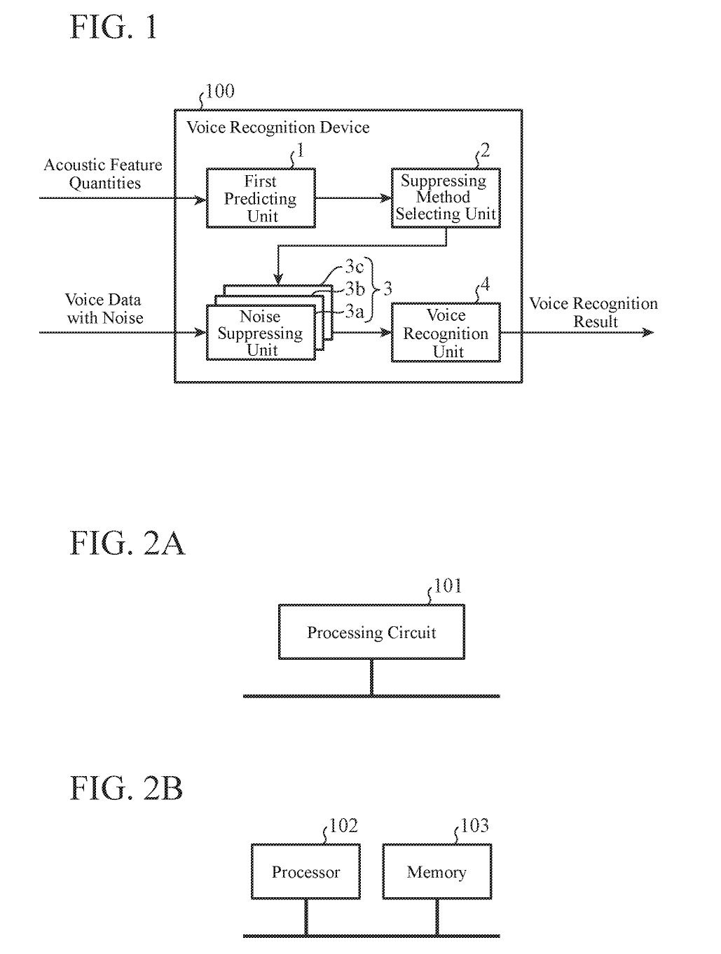

FIG. 1 is a block diagram showing a configuration of a voice recognition device 100 according to the Embodiment 1.

The voice recognition device 100 is configured to include a first predicting unit 1, a suppressing method selecting unit 2, a noise suppressing unit 3, and a voice recognition unit 4.

The first predicting unit 1 is configured by a regression unit. As the regression unit, for example, a neural network (referred to as an NN hereafter) is constructed and applied. In the construction of the NN, the NN that, as the regression unit, directly calculates a voice recognition rate equal to or greater than 0 and equal to or less than 1 using acoustic feature quantities which is generally used, such as the Mel-frequency Cepstral Coefficient (MFCC) or a filter bank feature, is constructed using, for example, the error back propagation method or the like. The error back propagation method is a learning method of, when certain learning data is provided, correcting connection weights and biases among layers and the like in such a way that errors between the learning data and the output of the NN become small. The first predicting unit 1 predicts a voice recognition rate of acoustic feature quantities inputted thereto using, for example, the NN whose input is acoustic feature quantities and whose output is the voice recognition rate.

The suppressing method selecting unit 2 refers to the voice recognition rates predicted by the first predicting unit 1 and selects a noise suppressing unit 3 which carries out noise suppression from a plurality of noise suppressing units 3a, 3b, and 3c. The suppressing method selecting unit 2 outputs a control instruction to perform a noise suppressing process to the selected noise suppressing unit 3. The noise suppressing unit 3 consists of the plurality of noise suppressing units 3a, 3b, and 3c, and the noise suppressing units 3a, 3b, and 3c perform their respective noise suppressing processes which are different from each other on the voice data with noise inputted thereto. As the noise suppressing processes which are different from each other, for example, a spectral subtraction method (SS), an adaptive filter method in which a learning identification method (Normalized Least Mean Square Algorithm; NLMS algorithm) or the like is applied, a method using an NN such as a Denoising auto encoder, and so on can be applied. Further, which one of the noise suppressing units 3a, 3b, and 3c performs a noise suppressing process is decided on the basis of the control instruction inputted from the suppressing method selecting unit 2. Although in the example of FIG. 1 the example in which the noise suppressing unit 3 consists of three noise suppressing units 3a, 3b, and 3c is shown, the number of noise suppressing units is not limited to three and can be changed as appropriate.

The voice recognition unit 4 carries out voice recognition on the voice data in which a noise signal is suppressed by a noise suppressing unit 3, and outputs a voice recognition result. In the voice recognition, the voice recognition process is performed using, for example, an acoustic model based on the Gaussian mixture model or the Deep neural network, and a language model based on n-gram. Because the voice recognition process can be configured by applying known techniques, the detailed explanation of the voice recognition process will be omitted hereafter.

The first predicting unit 1, the suppressing method selecting unit 2, the noise suppressing units 3, and the voice recognition unit 4 of the voice recognition device 100 are implemented by a processing circuit. The processing circuit can be hardware for dedicated use, a CPU (Central Processing Unit), a processing device, or a processor that executes a program stored in a memory, or the like.

FIG. 2A shows a hardware configuration of the voice recognition device 100 according to the Embodiment 1, and shows a block diagram in a case in which the processing circuit is implemented by hardware. As shown in FIG. 2A, in a case in which the processing circuit 101 is hardware for dedicated use, the functions of the first predicting unit 1, the suppressing method selecting unit 2, the noise suppressing units 3, and the voice recognition unit 4 can be implemented by respective processing circuits, or the functions of the units can be implemented together by a processing circuit.

FIG. 2B shows a hardware configuration of the voice recognition device 100 according to the Embodiment 1, and shows a block diagram in a case in which the processing circuit is implemented by software.

As shown in FIG. 2B, in a case in which the processing circuit is a processor 102, each of the functions of the first predicting unit 1, the suppressing method selecting unit 2, the noise suppressing units 3, and the voice recognition unit 4 is implemented by software, firmware, or a combination of software and firmware. The software or the firmware is described as a program and stored in a memory 103. The processor 102 performs the function of each of the units by reading and executing the program stored in the memory 103. The memory 103 is, for example, a non-volatile or volatile semiconductor memory such as a RAM, a ROM, or a flash memory, or a magnetic disc, an optical disc, or the like.

As described above, the processing circuit can implement each of the above-mentioned functions using hardware, software, firmware, or a combination of some of these elements.

Next, a detailed configuration of the first predicting unit 1 and the suppressing method selecting unit 2 will be explained.

First, the first predicting unit 1 to which a regression unit is applied is configured by the NN that receives acoustic feature quantities as an input and outputs a voice recognition rate. When acoustic feature quantities are inputted for every frame of a short-time Fourier transform, the first predicting unit 1 predicts the voice recognition rates for the noise suppressing units 3a, 3b, and 3c, respectively, on the basis of the NN. Namely, the first predicting unit 1 calculates, for each of the frames of the acoustic feature quantities, the respective voice recognition rates in the case of applying the noise suppressing processes being different to each other. The suppressing method selecting unit 2 refers to the voice recognition rates in the case of applying the noise suppressing units 3a, 3b, and 3c, respectively, which are calculated by the first predicting unit 1, selects the noise suppressing unit 3 which derives the voice recognition result having the highest voice recognition rate, and outputs a control instruction to the selected noise suppressing unit 3.

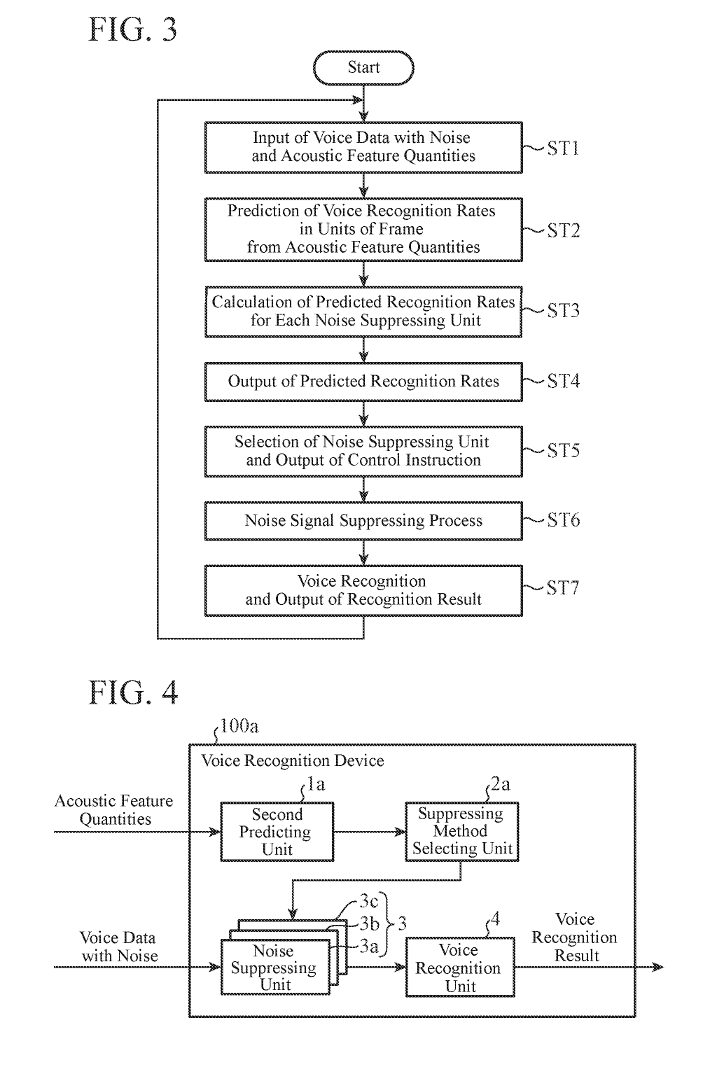

FIG. 3 is a flow chart showing an operation of the voice recognition device 100 according to the Embodiment 1.

It is assumed that voice data with noise and acoustic feature quantities of the voice data with noise are inputted to the voice recognition device 100 via an external microphone or the like. The acoustic feature quantities of the voice data with noise is assumed to be calculated by an external feature quantity calculating means.

When voice data with noise and acoustic feature quantities of the voice data with noise are inputted (step ST1), the first predicting unit 1 uses the NN to predict the voice recognition rates which will be provided, respectively, by the noise suppressing units 3a, 3b, and 3c performing noise suppressing processes, in units of frame of the short-time Fourier transform of the inputted acoustic feature quantities (step ST2). The process of the step ST2 is repeatedly performed on a plurality of set frames. The first predicting unit 1 calculates the average, the maximum, or the minimum of the plurality of voice recognition rates predicted respectively in units of frame and for the plurality of frames in the step ST2, and on the basis of those values, calculates predicted recognition rates which will be provided by the noise suppressing units 3a, 3b, and 3c performing their respective processes (step ST3). The first predicting unit 1 outputs the calculated predicted recognition rates to the suppressing method selecting unit 2 to be linked to the noise suppressing units 3a, 3b, and 3c (step ST4).

The suppressing method selecting unit 2 refers to the predicted recognition rates outputted in the step ST4, selects the noise suppressing unit 3 which shows the highest predicted recognition rate, and outputs a control instruction to perform a noise suppressing process to the selected noise suppressing unit 3 (step ST5). The noise suppressing unit 3 to which the control instruction is inputted in the step ST5 performs a process of suppressing a noise signal on the actual voice data with noise inputted in the step ST1 (step ST6). The voice recognition unit 4 carries out voice recognition on the voice data in which the noise signal is suppressed in the step ST6 and outputs the acquired voice recognition result (step ST7). After that, the processing returns to the step ST1 in the flowchart, and the above-described processing is repeated.

As described above, according to this Embodiment 1, the voice recognition device is configured to include: the first predicting unit 1 that is configured by an NN being configured with a regression unit that receives acoustic feature quantities as an input and outputs voice recognition rates; a suppressing method selecting unit 2 that refers to the voice recognition rates predicted by the first predicting unit 1, selects the noise suppressing unit 3 which derives the voice recognition result having the highest voice recognition rate from the plurality of noise suppressing units 3, and outputs a control instruction to the selected noise suppressing unit 3; the noise suppressing unit 3 that includes a plurality of processing units to which a plurality of noise suppressing methods is applied, respectively, and that performs a noise suppressing process on the voice data with noise on the basis of the control instruction from the suppressing method selecting unit 2; and the voice recognition unit 4 that carries out voice recognition on the voice data on which the noise suppressing process is performed. As a result, an effective noise suppressing method can be selected without increasing the amount of processing of the voice recognition and without performing noise suppressing process in order to select a noise suppressing method.

For example, in conventional techniques, when there are three candidates for the noise suppressing method, noise suppressing processes are performed by all of the three methods, and the best noise suppressing process is selected on the basis of the results of the noise suppressing processes. In contrast, according to this Embodiment 1, even when there are three candidates for the noise suppressing method, the noise suppressing method which is considered to have the best performance can be predicted in advance. Consequently, the amount of calculation required for the noise suppressing process can be advantageously reduced by performing the noise suppressing process only by the selected method.

### Embodiment 2

In the above Embodiment 1, the configuration in which a noise suppressing unit 3 which derives a voice recognition result having a high voice recognition rate is selected using a regression unit is shown. In this Embodiment 2, a configuration in which a noise suppressing unit 3 which derives a voice recognition result having a high voice recognition rate is selected using an identification unit will be shown.

FIG. 4 is a block diagram showing a configuration of the voice recognition device 100a according to the Embodiment 2.

The voice recognition device 100a according to the Embodiment 2 is configured to include a second predicting unit 1a and a suppressing method selecting unit 2a, instead of the first predicting unit 1 and the suppressing method selecting unit 2 of the voice recognition device 100 shown in the Embodiment 1. Hereafter, the same or corresponding components as those of the voice recognition device 100 according to the Embodiment 1 are denoted by the same reference signs as those used in the Embodiment 1, and the explanation of the components will be omitted or simplified.

The second predicting unit 1a is configured by an identification unit. As the identification unit, for example, the NN is constructed and applied. In the construction of the NN, the NN that, as the identification unit, performs a classifying process such as a binary classification or a multiclass classification using acoustic feature quantities which are used generally, such as the MFCC or the filter bank feature, and that selects the identifier of a suppressing method having the highest recognition rate is configured by using an error back propagation method. The second predicting unit la is configured by, for example, the NN that receives acoustic feature quantities as an input, carries out a binary or multiclass classification by setting a final output layer as a softmax layer, and outputs the identification (ID) of the suppressing method which derives the voice recognition result having the highest voice recognition rate. As the training data of the NN, a vector in which “1” is set only to the suppressing method which derives a voice recognition result having the highest voice recognition rate and “0” is set to each of the other methods, or weighted data (Sigmoid ((the recognition rate of this system−(max(recognition rates)−min(recognition rates)/2))/σ) which is acquired by multiplying recognition rates by Sigmoid or the like can be used. σ is a scaling factor.

Needless to say, other classifiers such as the SVM (support vector machine) can also be used.

The suppressing method selecting unit 2a refers to the suppressing method ID predicted by the second predicting unit 1a, and selects the noise suppressing unit 3 which carries out noise suppression from a plurality of noise suppressing units 3a, 3b, and 3c. The spectral subtraction method (SS), the adaptive filter method, a method using the NN, and so on can be applied to the noise suppressing units 3, like in the case of the Embodiment 1. The suppressing method selecting unit 2a outputs a control instruction to perform a noise suppressing process to the selected noise suppressing unit 3.

Next, the operation of the voice recognition device 100a will be explained.

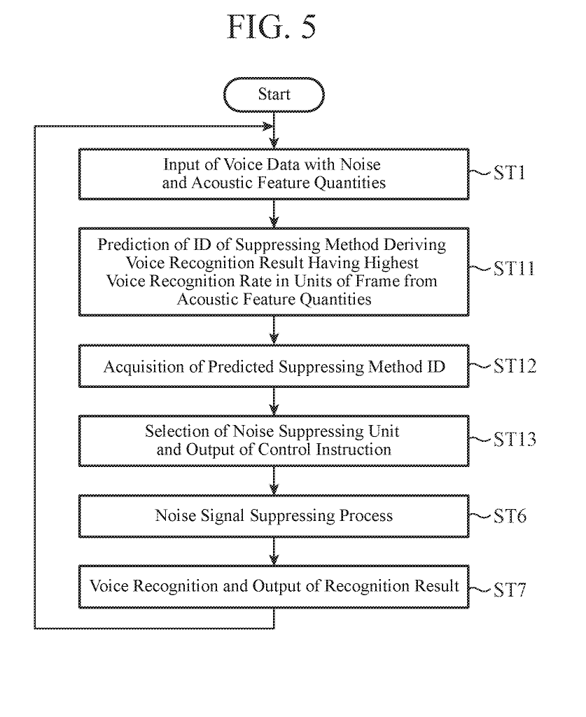

FIG. 5 is a flowchart showing the operation of the voice recognition device 100a according to the Embodiment 2. Hereafter, the same steps as those of the voice recognition device 100 according to the Embodiment 1 are denoted by the same reference signs as those used in FIG. 3, and the explanation of the steps will be omitted or simplified.

It is assumed that voice data with noise and acoustic feature quantities of the voice data with noise are inputted to the voice recognition device 100a via an external microphone or the like.

When voice data with noise and acoustic feature quantities of the voice data with noise are inputted (step ST1), the second predicting unit 1a predicts, using the NN, the suppressing method ID of the noise suppressing method which derives the voice recognition result having the highest voice recognition rate in units of frame of the short-time Fourier transform of the inputted acoustic feature quantities (step ST11).

The second predicting unit 1a obtains the most frequently predicted one or the average of the plurality of suppressing method IDs predicted in units of frame in the step ST11 and acquires the suppressing method ID which is the most frequently predicted one or the average as the predicted suppressing method ID (step ST12). The suppressing method selecting unit 2a refers to the predicted suppressing method ID acquired in the step ST12, selects the noise suppressing unit 3 corresponding to the predicted suppressing method ID acquired, and outputs a control instruction to perform a noise suppressing process to the selected noise suppressing unit 3 (step ST13). After that, the same processes as those in the steps ST6 and ST7 shown in the Embodiment 1 are performed.

As described above, the voice recognition device according to this Embodiment 2 is configured to include: the second predicting unit 1a to which an identification unit is applied, and which is configured by an NN that receives acoustic feature quantities as an input and outputs the ID of the suppressing method which derives the voice recognition result having the highest voice recognition rate; the suppressing method selecting unit 2a that selects, with reference to the suppressing method ID predicted by the second predicting unit 1a, the noise suppressing unit 3 which derives the voice recognition result having the highest voice recognition rate from the plurality of noise suppressing units 3, and outputs a control instruction to the selected noise suppressing unit 3; the noise suppressing unit 3 that includes a plurality of processing units respectively corresponding to a plurality of noise suppressing methods, and performs noise suppression on voice data with noise in accordance with the control instruction from the suppressing method selecting unit 2a; and the voice recognition unit 4 that carries out voice recognition on the voice data on which the noise suppressing process is performed. As a result, an effective noise suppressing method can be selected without increasing the amount of processing of the voice recognition and without performing noise suppressing process in order to select a noise suppressing method.

### Embodiment 3

In the above-mentioned Embodiments 1 and 2, the configuration in which acoustic feature quantities are inputted to the first predicting unit 1 or the second predicting unit 1a for every frame of the short-time Fourier transform, and the voice recognition rate or the suppressing method ID is predicted for each inputted frame is shown. In contrast, in this Embodiment 3, a configuration in which, by using acoustic feature quantities in units of utterance, an utterance having acoustic feature quantities which are the nearest to the acoustic feature quantities of the voice data with noise actually inputted to a voice recognition device is selected from data learned in advance, and a noise suppressing unit is selected on the basis of the voice recognition rate of the selected utterance will be shown.

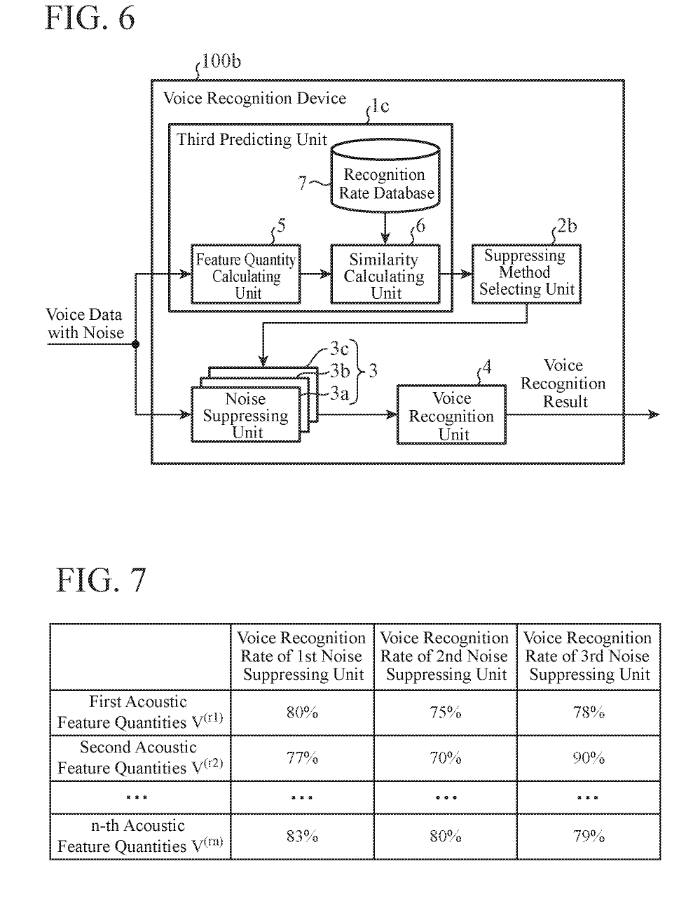

FIG. 6 is a block diagram showing a configuration of the voice recognition device 100b according to the Embodiment 3.

The voice recognition device 100b according to the Embodiment 3 is configured to include: a third predicting unit 1c provided with a feature quantity calculating unit 5, a degree of similarity calculating unit 6, and a recognition rate database 7; and a suppressing method selecting unit 2b, instead of the first predicting unit 1 and the suppressing method selecting unit 2 of the voice recognition device 100 shown in the Embodiment 1.

Hereafter, the same or corresponding components as those of the voice recognition device 100 according to the Embodiment 1 are denoted by the same reference signs as those used in the Embodiment 1, and the explanation of the components will be omitted or simplified.

The feature quantity calculating unit 5 which constitutes a part of the third predicting unit 1c calculates acoustic feature quantities in units of utterance from input voice data with noise. The details of a method of calculating acoustic feature quantities in units of utterance will be described later. The degree of similarity calculating unit 6 compares, with reference to the recognition rate database 7, the acoustic feature quantities in units of utterance which is calculated by the feature quantity calculating unit 5 with acoustic feature quantities stored in the recognition rate database 7, and calculates the degree of similarity between them. The degree of similarity calculating unit 6 acquires a set of voice recognition rates which are provided when the noise suppressing units 3a, 3b, and 3c perform noise suppression, respectively, for the acoustic feature quantities having the highest degree of similarity among the calculated degrees of similarity, and outputs the set of voice recognition rates to the suppressing method selecting unit 2b. The set of voice recognition rates is, for example, “the voice recognition rate₁₋₁, the voice recognition rate₁₋₂, and the voice recognition rate₁₋₃”, “the voice recognition rate₂₋₁, the voice recognition rate₂₋₂, and the voice recognition rate₂₋₃”, or the like. The suppressing method selecting unit 2b refers to the set of voice recognition rates which is inputted thereto from the degree of similarity calculating unit 6, and selects the noise suppressing unit 3 which carries out noise suppression from the plurality of noise suppressing units 3a, 3b, and 3c.

The recognition rate database 7 is a storage area in which acoustic feature quantities of each of a plurality of learning data, and voice recognition rates, which are provided when the noise suppressing units 3a, 3b, and 3c carry out noise suppression on the acoustic feature quantities, respectively, are stored to be linked to each other.

FIG. 7 is a diagram showing an example of the configuration of the recognition rate database 7 of the voice recognition device 100b according to the Embodiment 3.

The recognition rate database 7 stores the acoustic feature quantities of each learning data, and the voice recognition rates of voice data, which are provided when the noise suppressing units (in the example of FIG. 7, the first, second, and third noise suppressing units) perform respective noise suppressing processes on the learning data, to be linked to each other. In FIG. 7, for example, with respect to the learning data having a first acoustic feature quantities V^{(r1)}, the voice recognition rate of the voice data is 80% when the first noise suppressing unit performs a noise suppressing process, 75% when the second noise suppressing unit performs a noise suppressing process, and 78% when the third noise suppressing unit performs a noise suppressing process. As an alternative, the recognition rate database 7 maybe configured to suppress the amount of the stored data by clustering the learning data and storing the recognition rates of the clustered learning data and the acoustic feature quantities to be linked to each other.

Next, the details of calculation of the acoustic feature quantities in units of utterance which is carried out by the feature quantity calculating unit 5 will be explained.

As the acoustic feature quantities in units of utterance, the average vector of the acoustic feature quantities, the average likelihood vector based on the Universal background model (UBM), the i-vector, or the like can be applied. The feature quantity calculating unit 5 calculates the above acoustic feature quantities in units of utterance for each voice data with noise which is an object to be recognized. For example, when the i-vector is applied as the acoustic feature quantities, the super vector V^{(r)} which is acquired by adapting the Gaussian mixture model (GMM) to the utterance r is factorized on the basis of the equation (1) below, using a preliminary acquired UBM-based super vector v and the matrix T which consists of basis vectors spanning a low rank whole variable plane.

V^{(r)}=v+Tw^{(r)} (1)

w^{(r)} acquired by the above equation (1) is the i-vector.

The similarity of the acoustic feature quantities in units of utterances is measured using either the Euclidean distance or the cosine similarity, as shown in the following equation (2), and the utterance r′ₜ which is the nearest to the current evaluation data rₑ is selected from the learning data rₜ. By expressing the degree of similarity by sim, the utterance expressed by the following equation (3) is selected.

$$\begin{matrix}sim ( {w}^{( {r}_{e} )} , {w}^{( {r}_{t} )} ) = \frac{{w}^{( {r}_{e} )} \cdot {w}^{( {r}_{t} )}}{\vert {w}^{( {r}_{e} )} \vert \vert {w}^{( {r}_{t} )} \vert} & ( 2 ) \\ {r}_{t}^{′} = {argmax}_{{r}_{t}} sim ( {w}^{{r}_{e}} , {w}^{{r}_{t}} ) & ( 3 )\end{matrix}$$

By acquiring a word error rate Wₜᵣ (i, rₜ) for the learning data rₜ in advance using the i-th noise suppressing unit 3 and the voice recognition unit 4, the system i′ optimal for re is selected on the basis of the recognition performance, as shown in the following equation (4).

$${i}^{′} = {argmin}_{i} {W}_{tr} ( i , {r}_{t}^{′} ) \qquad ( 4 )$$

Although the above explanation is made by taking, as an example, the case in which the number of noise suppressing methods is two, this embodiment can also be applied to a case in which the number of noise suppressing methods is three or more.

Next, the operation of the voice recognition device 100b will be explained.

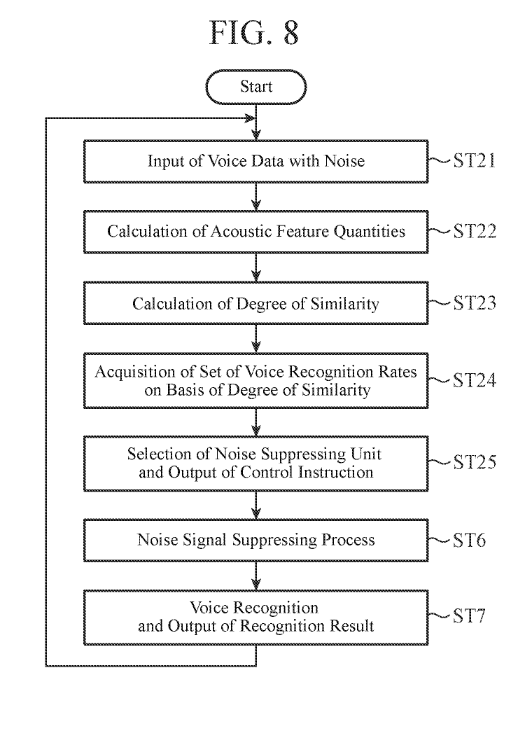

FIG. 8 is a flowchart showing the operation of the voice recognition device 100b according to the Embodiment 3. Hereafter, the same steps as those of the voice recognition device 100 according to the Embodiment 1 are denoted by the same reference signs as those in FIG. 3, and the explanation of the steps will be omitted or simplified.

It is assumed that voice data with noise is inputted to the voice recognition device 100b via an external microphone or the like.

When voice data with noise is inputted (step ST21), the feature quantity calculating unit 5 calculates acoustic feature quantities from the voice data with noise inputted thereto (step ST22). The degree of similarity calculating unit 6 compares the acoustic feature quantities calculated in the step ST22 with the acoustic feature quantities of each learning data stored in the recognition rate database 7, and calculates the degree of similarity between them (step ST23). The degree of similarity calculating unit 6 selects the acoustic feature quantities which shows the highest degree of similarity among the degrees of similarity between acoustic feature quantities which are calculated in the step ST23, and acquires a set of recognition rates correspondence to the selected acoustic feature quantities by referring to the recognition rate database 7 (step ST24). When the Euclidean distance is used in the step ST24 as the degree of similarity between acoustic feature quantities, the set of recognition rates having the shortest distance is acquired.

The suppressing method selecting unit 2b selects the noise suppressing unit 3 which shows the highest recognition rate in the set of recognition rates acquired in the step ST24, and outputs a control instruction to perform a noise suppressing process to the selected noise suppressing unit 3 (step ST25). After that, the same processes as those in the steps ST6 and ST7 described before are performed.

As described above, according to this Embodiment 3, the voice recognition device is configured to include: the feature quantity calculating unit 5 that calculates acoustic feature quantities from voice data with noise; the degree of similarity calculating unit 6 that calculates, with reference to the recognition rate database 7, the degree of similarity between the calculated acoustic feature quantities and the acoustic feature quantities of the learning data, and acquires a set of voice recognition rates which is linked to the acoustic feature quantities which show the highest degree of similarity; and the suppressing method selecting unit 2b that selects a noise suppressing unit 3 which shows the highest voice recognition rate in the acquired set of voice recognition rates. As a result, there is provided an advantage of being able to predict voice recognition performance in units of utterance, predicting voice recognition performance with a high degree of accuracy, and facilitating the calculation of the degree of similarity by using fixed-dimensional feature quantities.

In the above-described Embodiment 3, the configuration in which the voice recognition device 100b includes the recognition rate database 7 is shown. Alternatively, the voice recognition device 100b may be configured such that, with reference to an external database, the degree of similarity calculating unit 6 carries out the calculation of the degree of similarity between acoustic feature quantities and acquisition of the recognition rates.

In the above Embodiment 3, when the voice recognition is carried out in units of utterance, a delay occurs. In a case in which such a delay cannot be permitted, the voice recognition device 100b may be configured to refer to acoustic feature quantities by using a beginning part of several seconds of an utterance immediately after the time when the utterance is started. Further, when the environment does not change between an utterance which was provided before the utterance which is the current target for voice recognition and the current utterance, the voice recognition device 100b may be configured to carry out the voice recognition using the selection result of a noise suppressing unit 3 which was carried out for the previous utterance.

### Embodiment 4

In the above Embodiment 3, the configuration in which a noise suppressing method is selected by referring to the recognition rate database 7 in which the acoustic feature quantities of learning data and the voice recognition rates are linked to each other is shown. In this Embodiment 4, a configuration in which a noise suppressing method is selected by referring to an acoustic index database in which the acoustic feature quantities of learning data and acoustic indexes are linked to each other will be shown.

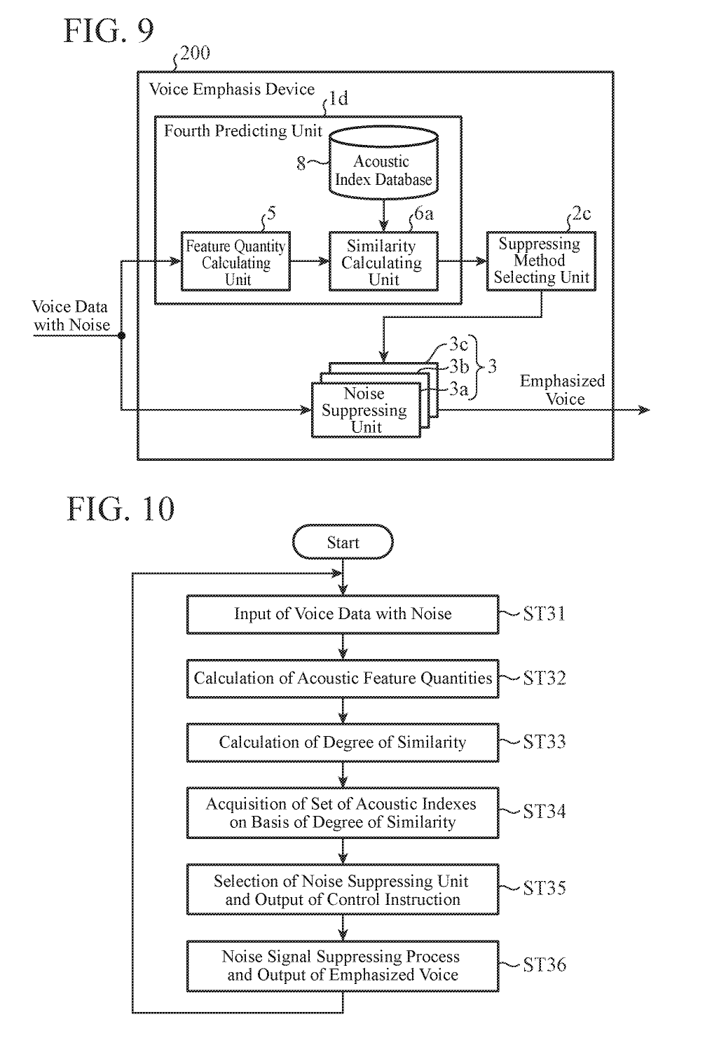

FIG. 9 is a block diagram showing the configuration of a voice emphasis device 200 according to the Embodiment 4.

The voice emphasis device 200 according to the Embodiment 4 is configured to include a fourth predicting unit 1d provided with a feature quantity calculating unit 5, a degree of similarity calculating unit 6a, and an acoustic index database 8, and a suppressing method selecting unit 2c, instead of the third predicting unit 1c provided with the feature quantity calculating unit 5, the degree of similarity calculating unit 6, and the recognition rate database 7, and the suppressing method selecting unit 2b of the voice recognition device 100b which are shown in the Embodiment 3. Further, the voice emphasis device does not include the voice recognition unit 4.

Hereafter, the same or corresponding components as those of the voice recognition device 100b according to the Embodiment 3 are denoted by the same reference signs as those used in the Embodiment 3, and the explanation of the components will be omitted or simplified.

The acoustic index database 8 is a storage area in which acoustic feature quantities of each of a plurality of learning data and acoustic indexes which are provided when the noise suppressing units 3a, 3b, and 3c performs noise suppression on the learning data, respectively, are stored to be linked to each other. The acoustic index is PESQ, SNR/SDR, or the like which is calculated from an emphasized voice in which noise is suppressed, and a noise sound before the noise suppression. As an alternative, the acoustic index database 8 may be configured to suppress the amount of the stored data by clustering the learning data and storing the acoustic indexes of the clustered learning data and the acoustic feature quantities to be linked to each other.

The degree of similarity calculating unit 6a compares, with reference to the acoustic index database 8, the acoustic feature quantities in units of utterance which is calculated by the feature quantity calculating unit 5 with the acoustic feature quantities stored in the acoustic index database 8, and calculates the degree of similarity between those acoustic feature quantities. The degree of similarity calculating unit 6a acquires a set of acoustic indexes which are linked to the acoustic feature quantities having the highest degree of similarity among the calculated degrees of similarity, and outputs the set of acoustic indexes to the suppressing method selecting unit 2c. The set of acoustic indexes is, for example, “PESQ₁₋₁, PESQ₁₋₂, and PESQ₁₋₃”, “PESQ₂₋₁, PESQ₂₋₂, and PESQ₂₋₃”, or the like.

The suppressing method selecting unit 2c refers to the set of acoustic indexes which is inputted from the degree of similarity calculating unit 6a, and selects a noise suppressing unit 3 which carries out noise suppression from the plurality of noise suppressing units 3a, 3b, and 3c.

Next, the operation of the voice emphasis device 200 will be explained.

FIG. 10 is a flowchart showing the operation of the voice emphasis device 200 according to the Embodiment 4. It is assumed that voice data with noise is inputted to the voice emphasis device 200 via an external microphone or the like.

When voice data with noise is inputted (step ST31), the feature quantity calculating unit 5 calculates acoustic feature quantities from the voice data with noise inputted thereto (step ST32). The degree of similarity calculating unit 6a compares the acoustic feature quantities calculated in the step ST32 with the acoustic feature quantities of the learning data stored in the acoustic index database 8, and calculates the degree of similarity between them (step ST33). The degree of similarity calculating unit 6a selects the acoustic feature quantities which shows the highest degree of similarity among the degrees of similarity between acoustic feature quantities which are calculated in the step ST33, and acquires a set of acoustic indexes which are linked to the selected acoustic feature quantities (step ST34).

The suppressing method selecting unit 2c selects the noise suppressing unit 3 which shows the highest acoustic index in the set of acoustic indexes acquired in the step ST34, and outputs a control instruction to perform a noise suppressing process to the selected noise suppressing unit 3 (step ST35). The noise suppressing unit 3 to which the control instruction is inputted in the step ST35 acquires an emphasized voice by performing a process of suppressing a noise signal on the actual voice data with noise inputted in the step ST31 and outputs the emphasized voice (step ST36). After that, the process returns to the step ST31, and the above-described processing is repeated.

As described above, the voice emphasis device according to this Embodiment 4 is configured to include: the feature quantity calculating unit 5 that calculates acoustic feature quantities from voice data with noise; the degree of similarity calculating unit 6a, that calculates, with reference to the acoustic index database 8, the degree of similarity between the calculated acoustic feature quantities and the acoustic feature quantities of the learning data, and acquires a set of acoustic indexes which is linked to the acoustic feature quantities which shows the highest degree of similarity; and the suppressing method selecting unit 2c that selects the noise suppressing unit 3 which shows the highest acoustic index in the acquired set of acoustic indexes. As a result, there is provided an advantage of being able to predict voice recognition performance in units of utterance, and predicting voice recognition performance with a high degree of accuracy and facilitating the calculation of the degree of similarity by using fixed-dimensional feature quantities.

In the above-described Embodiment 4, the configuration in which the voice emphasis device 200 includes the acoustic index database 8 is shown. Alternatively, the voice emphasis device 200 may be configured such that the degree of similarity calculating unit 6a carries out, with reference to an external database, the calculation of the degree of similarity between acoustic feature quantities, and the acquisition of acoustic indexes.

In the above-mentioned Embodiment 4, when the voice recognition is carried out in units of utterance, a delay occurs. In a case where such a delay cannot be permitted, the voice recognition device 100b may be configured to refer to acoustic feature quantities by using a beginning part of several seconds of an utterance immediately after the time when the utterance is started. Further, when the environment does not change between an utterance which was provided before the utterance which is the target for emphasized voice acquisition, and the current utterance, the voice emphasis device 200 may be configured to carry out the emphasized voice acquisition using the selection result of a noise suppressing unit 3 which was carried out for the previous utterance.

### Embodiment 5

The voice recognition devices 100, 100a, and 100b according to the Embodiments 1 to 3 and the voice emphasis device 200 according to the Embodiment 4 which are described before can be applied to, for example, a navigation system, a telephone reception system, an elevator, and so on each provided with a voice call function. In this Embodiment 5, a case in which the voice recognition device according to the Embodiment 1 is applied to a navigation system will be shown.

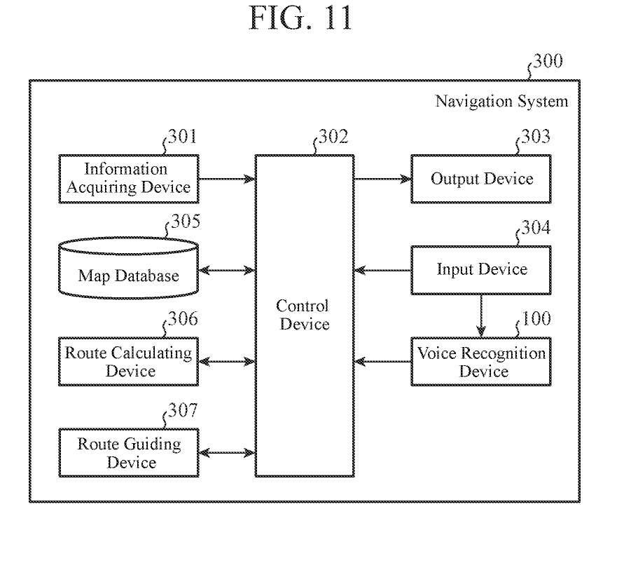

FIG. 11 is a functional block diagram showing the configuration of the navigation system 300 according to the Embodiment 5.

The navigation system 300 is a device that is mounted in, for example, a vehicle and that performs guidance of a route to a destination, and includes an information acquiring device 301, a control device 302, an output device 303, an input device 304, the voice recognition device 100, a map database 305, a route calculating device 306, and a route guiding device 307. The operation of each of the devices of the navigation system 300 is controlled integratedly by the control device 302.

The information acquiring device 301 includes, for example, a current position detection means, a wireless communication means, a surroundings information detection means, and so on, and acquires the current position of user's vehicle, information detected in the surroundings of user's vehicle, and information detected in other vehicles. The output device 303 includes, for example, a display means, a display control means, a sound output means, a sound control means, and so on, and notifies a user of information. The input device 304 is implemented by a voice input means such as a microphone, and an operation input means such as buttons or a touch panel, and receives information inputted by a user. The voice recognition device 100 has the configuration and the functions which are shown in the Embodiment 1, carries out voice recognition on voice data with noise inputted via the input device 304, acquires a voice recognition result, and outputs this voice recognition result to the control device 302.

The map database 305 is a storage area that stores map data, and is implemented by, for example, a storage device such as a Hard Disk Drive (HDD) or a Random Access Memory (RAM). The route calculating device 306 sets the current position of user's vehicle acquired by the information acquiring device 301 as the place of departure, sets the voice recognition result acquired by the voice recognition device 100 as the destination, and calculates a route from the place of departure to the destination on the basis of the map data stored in the map database 305. The route guiding device 307 guides user's vehicle in accordance with the route calculated by the route calculating device 306.

In the navigation system 300, when voice data with noise including user's utterance is inputted from the microphone which constructs the input device 304, the voice recognition device 100 performs processing shown in the flow chart of FIG. 3 explained before on the voice data with noise, and acquires a voice recognition result. The route calculating device 306 sets the current position of user's vehicle acquired by the information acquiring device 301 as the place of departure and sets the information shown by the voice recognition result as the destination, on the basis of the pieces of information inputted from the control device 302 and the information acquiring device 301, and calculates a route from the place of departure to the destination on the basis of the map data. The route guiding device 307 outputs information about route guidance which is calculated in accordance with the route calculated by the route calculating device 306 via the output device 303, and provides the route guidance for the user.

As described above, the navigation system according to this Embodiment 5 is configured in such a way that the voice recognition device 100 performs a noise suppressing process on voice data with noise which is inputted to the input device 304 and which includes user's utterance by using the noise suppressing unit 3 which is predicted to derive a voice recognition result showing a good voice recognition rate, and carries out voice recognition on the voice data. As a result, the calculation of a route can be carried out on the basis of the voice recognition result having a good voice recognition rate so that route guidance suitable for user's desire can be carried out.

In the above-described Embodiment 5, the configuration in which the voice recognition device 100 shown in the Embodiment 1 is applied to the navigation system 300 is shown. Alternatively, the navigation system 300 may be configured using the voice recognition device 100a shown in the Embodiment 2, the voice recognition device 100b shown in the Embodiment 3, or the voice emphasis device 200 shown in the Embodiment 4. In a case in which the voice emphasis device 200 is applied to the navigation system 300, it is assumed that the navigation system 300 has a function of carrying out voice recognition on an emphasized voice.

Note that, in addition to the above-described embodiments, any combination of the above-described embodiments can be made, various changes can be made in any component according to any one of the above-mentioned embodiments, and any component according to any one of the above-mentioned embodiments can be omitted within the scope of the invention.

### INDUSTRIAL APPLICABILITY

Since the voice recognition device and the voice emphasis device according to the present invention can select a noise suppressing method which provides a good voice recognition rate or a good acoustic index, they can be applied to a device provided with a voice call function, such as a navigation system, a telephone reception system, or an elevator.

### REFERENCE SIGNS LIST

1 first predicting unit, 1a second predicting unit, 2, 2a, and 2b suppressing method selecting unit, 3, 3a, 3b, and 3c noise suppressing unit, 4 voice recognition unit, 5 feature quantity calculating unit, 6 and 6a degree of similarity calculating unit, 7 recognition rate database, 8 acoustic index database, 100, 100a and 100b voice recognition device, 200 voice emphasis device, 300 navigation system, 301 information acquiring device, 302 control device, 303 output device, 304 input device, 305 map database, 306 route calculating device, and 307 route guiding device.

1-9. (canceled)

10. A voice recognition device comprising:
plural noise suppressors performing respective noise suppressing processes using different methods on voice data with noise inputted thereto;
a voice recognizer carrying out voice recognition on sound data generated by suppressing a noise signal in the voice data with noise by one of the noise suppressors;
a predictor predicting, from acoustic feature quantities of the voice data with noise being inputted, voice recognition rates which are to be provided when the noise suppressing processes are performed on the voice data with noise by the plural noise suppressors, respectively; and
a suppressing method selector selecting a noise suppressor which performs a noise suppressing process on the voice data with noise from the plural noise suppressors on a basis of the voice recognition rates predicted by the predictor.

11. The voice recognition device according to claim 10, wherein the predictor predicts the voice recognition rates in units of frame of a short-time Fourier transform of the acoustic feature quantities.

12. The voice recognition device according to claim 10, wherein the predictor is configured by a neural network that receives the acoustic feature quantities as an input and outputs the voice recognition rates of the acoustic feature quantities.

13. The voice recognition device according to claim 10, wherein the predictor is configured by a neural network that receives the acoustic feature quantities as an input, performs a classifying process on the acoustic feature quantities, and outputs information identifying one of the plural noise suppressors which has a high voice recognition rate.

14. The voice recognition device according to claim 10, wherein the predictor includes: a feature quantity calculator calculating the acoustic feature quantities in units of utterance from the voice data with noise; and a degree of similarity calculator acquiring the voice recognition rates stored in advance on a basis of a degree of similarity between the acoustic feature quantities calculated by the feature quantity calculator and acoustic feature quantities stored in advance.

15. A voice emphasis device comprising:
plural noise suppressors performing respective noise suppressing processes using different methods on voice data with noise inputted thereto;
a predictor including: a feature quantity calculator calculating acoustic feature quantities in units of utterance from the voice data with noise being inputted; and a degree of similarity calculator acquiring acoustic indexes stored in advance on a basis of a degree of similarity between the acoustic feature quantities calculated by the feature quantity calculator and acoustic feature quantities stored in advance; and
a suppressing method selector selecting a noise suppressor which performs a noise suppressing process on the voice data with noise from the plural noise suppressors on a basis of the acoustic indexes acquired by the degree of similarity calculator.

16. A voice recognition method comprising:
a predictor predicting, from acoustic feature quantities of voice data with noise inputted thereto, voice recognition rates which are to be provided when plural noise suppressing processes are performed by plural noise suppressors on the voice data with noise, respectively;
a suppressing method selector selecting a noise suppressor which performs a noise suppressing process on the voice data with noise from the plural noise suppressors on a basis of the predicted voice recognition rates;
the noise suppressor which is selected performing the noise suppressing process on the inputted voice data with noise; and
a voice recognizer carrying out voice recognition on the sound data generated by suppressing a noise signal in the voice data with noise through the noise suppressing process.

17. A voice emphasis method comprising:
feature quantity calculator of a predictor calculating acoustic feature quantities in units of utterance from voice data with noise inputted thereto;
a degree of similarity calculator of the predictor acquiring acoustic indexes stored in advance on a basis of a degree of similarity between the calculated acoustic feature quantities, and acoustic feature quantities stored in advance;
a suppressing method selector selecting a noise suppressor which performs a noise suppressing process on the voice data with noise on a basis of the acquired acoustic indexes; and
the selected noise suppressor performing the noise suppressing process on the inputted voice data with noise.

18. A navigation device comprising:
the voice recognition device according to claim 10;
a route calculating device setting a current position of a moving object as a place of departure of the moving object and setting a voice recognition result which is an output of the voice recognition device as a destination of the moving object, and calculating a route from the place of departure to the destination by referring to map data; and
a route guiding device guiding a movement of the moving object along the route calculated by the route calculating device.
